(19) United States
(12) Patent Application Publication
(10) Pub. No.: US 2012/0096157 A1
(43) Pub. Date: Apr. 19, 2012

(54) METHOD AND APPARATUS FOR MANAGING AND PROCESSING INFORMATION AN OBJECT FOR MULTI-RESOURCE-STREAMING

(76) Inventor: Jae Wook Lee, Seoul (KR)

(21) Appl. No.: 12/666,782

(22) PCT Filed: Jun. 23, 2008
(86) PCT No.: PCT/KR08/03575

§ 371 Date: Oct. 14, 2010

Related U.S. Application Data
(60) Provisional application No. 60/946,322, filed on Jun. 26, 2007.

(30) Foreign Application Priority Data
Dec. 26, 2007 (KR) 10-2007-0137773

(51) Int. Cl. G06F 15/16

(52) U.S. Cl. 709/225

(57) ABSTRACT

The present invention provides method and apparatus for preparing and processing information on a stored content source. The present method includes: creating a plurality of first structure elements allocating mutually different identifiers to a primary component pertaining to a content source, and incorporating protocol information and access location information on the primary component into each of the plurality of first structure elements; and creating second structure elements as many as number of the plurality of first structure elements, and incorporating into each of the second structure elements protocol information and access location information on a resource that can be played along with the primary component wherein the second structure elements are respectively associated with the mutually different identifiers.

### TECHNICAL FIELD

The present invention is related to a method and an apparatus for managing information about content stored in a device on a UPnP network and processing information between networked devices according to the information.

### BACKGROUND ART

A UPnP™ (hereinafter, it is called “UPnP” for short) network proposed for home networking consists of a plurality of UPnP devices, services, and control points (CPs). A service on a UPnP network represents a smallest control unit on the network, which is modeled by state variables.

A CP (Control Point) on a UPnP network represents a control application equipped with functions for detecting and controlling other devices and/or services. A CP is operated on a physical device such as a PDA providing the user with a convenient interface.

As shown in FIG. 1, a UPnP AV home network comprises a media server (MS) 120 providing a home network with media data, a media renderer (MR) 130 playing media data through the home network, and an AV control point 110 controlling the media server 120 and the media renderer 130. The media server 120 and the media renderer 130 are controlled devices controlled by the control point 110.

The media server 120 (to be precise, CDS (Content Directory Service) 121 within the media server 120) stores media files and information of containers (which correspond to directories) as the corresponding object information. An ‘object’ is a comprehensive terminology indicating both an item having information about more than one media file and a container having information about a directory. Depending on circumstances, the terminology of ‘object’ can be used to specify either an item or a container. One item corresponds to one or more than one media file. For example, multiple media files of the same content but with different bit rates are managed as a single item.

FIG. 2 illustrates a simplified signal flow between devices and/or services during a media play procedure carried out in the network of FIG. 1.

First, the control point (CP) 110 obtains information about a protocol supported by the media renderer (MR) 130 (S01). The media server (MS) 120, to inform the control point 110 of information about a directory and media files under the corresponding directory, informs the control point 110 of information about a current directory and item information about media files under the directory each time a UPnP action 141 (e.g., a browsing action) is invoked (S10) in accordance with the user's request.

The CP 110 displays the received information about each individual object for the user through an appropriate UI (User Interface) (S11-1) after removing information about an item that does not follow the protocol supported by the media renderer 130. If the user selects an item (or a media file of particular quality belonging to the item) through a UI (S11-2), the CP 110 requests an action for preparing connection (PrepareForConnection( )) on the media server 120 and the media renderer 130 respectively for presentation of the selected media file (hereinafter, it is called ‘component’ or ‘media component’). The CP 110 then receives an instance ID about participating elements (CM: ConnectionManager, AVT: AVTransport service, and RCS: RenderingControl service) required for presentation by streaming between both devices 120, 130 (S12-1, S12-2). The instance ID is used for specifying and controlling a current streaming service. (For example, if sound volume is to be adjusted during rendering of a presentation stream, a SetVolume( ) action uses an instance ID of a previously received RCS (S15-1).) Next, the CP 110 links access location information about a previously selected component (e.g., URL (Universal Resource Locator) information) with an AVTransport service 133 through an action (S13) (in the example of FIG. 1, AVTransport service is installed in the media renderer 130 but it can also be installed in the media server 120). The CP 110 requests a play action on AVTransport service 133, the play action having AVTransport service instance ID as an input argument (S14), whereby data of a component selected through an appropriate information exchange procedure between the media renderer 130 and the media server 120 are streamed and presented by RCS 131 (S15).

If another media file is to be presented during the presentation (S15), the procedure described above steps (S11-2, S12-1, S12-2, S13, and S14) should be carried out again after the presentation has begun. Depending on circumstances, the steps S10 and S11-1 can also be carried out.

The above method for playing more than one component in a sequential order is not suitable for the case when more than one media component is played in synchronization with each other (hereinafter, media components associated with each other are called ‘multiple component’). One example is when a media component is a movie and the other component is a subtitle of the movie. This is because in case of sequential playback, synchronized presentation of a media renderer can be made difficult or impossible in accordance with time delay. Even for the case of a media source corresponding to a multiple component (one media source corresponds to one ‘content source’, e.g., a movie title), playback of a content source may cause playback of another one. In this case, too, playback of respective content sources must be done without time delay among the content sources to satisfy the user during the playback. The aforementioned situation can happen when the user tries to watch multiple content sources in the form of PIP (Picture in Picture).

### DISCLOSURE OF INVENTION

### Technical Problem

One objective of the present invention is to provide a method and an apparatus for organizing information about items and processing signals between devices and/or services according to the organized information to present multiple content sources.

Another objective of the present invention is to provide a method and an apparatus for managing individual connections of components belonging to more than one content source by groups.

### Technical Solution

A method of preparing information on a stored content source in accordance with the present invention includes: creating a plurality of first structure elements allocating mutually different identifiers to a primary component pertaining to a content source, and incorporating protocol information and access location information on the primary component into each of the plurality of first structure elements; and creating second structure elements as many as number of the plurality of first structure elements, and incorporating into each of the second structure elements protocol information and access location information on a resource that can be played along with the primary component, the second structure elements being respectively associated with the mutually different identifiers.

A method of conducting presentation of a content through data transfer over a network in accordance with the present invention includes: obtaining an identifier assigned to a first structure element that specifies protocol information and access location information on a selected primary component; selecting at least one component included in a second structure element associated with the obtained identifier; and conducting play-preparing operations for the primary component and the at least one component, and requesting play of the components after the play-preparing operations are finished for all of the components.

In an embodiment according to the present invention, if the second structure element includes information on mutually different types of resources, the second structure element includes a plurality of third structure elements that are separated each other and each of the third structure elements contains information on same type of resources. Further, the third structure element includes at least one particular structure element being capable of specifying protocol information and access location information on a resource and the particular structure element is different from the first structure element in name. For example, the first structure element is a tag named “res” and the particular structure element is a tag named “multiRes”. In addition, a type is assigned to the third structure element and the type is one among video, audio (or voice), subtitle, and selective combination thereof.

In an embodiment of the present invention, the type of the primary component is video and at least one resource selected from one of the second structure elements is a component, whose type is not video, to be playable in synchronization with the primary component.

In another embodiment of the present invention, the type of the primary component is video and at least one resource selected from one of the second structure elements is a component, whose type is video too, to be playable along with the primary component.

In an embodiment of the present invention, the play-preparing operations include, for each of the primary component and the selected at least one component: invoking a connection preparing action to obtain connection information from each of services to be involved in play operation; and invoking another action to set information necessary for component access to a play managing service. Further, the play requesting includes invoking play actions for the components individually.

In another embodiment of the present invention, the play-preparing operations include invoking an action to obtain group connection information from each of services to be involved in play operation and further include, for each of the primary component and the selected at least one component: invoking a connection preparing action to obtain connection information from each of services to be involved in play operation; and invoking another action to enlist the obtained connection information in the obtained group connection information, and invoking another action to set information necessary for component access to a play managing service. Further, the play requesting includes invoking a single play action using the group connection information. The another action to enlist the obtained connection information in the obtained group connection information includes input arguments containing the group connection information and connection information to enlist. In addition, the method of conducting presentation of a content further includes invoking an action to deallocate an enlisted connection information from the group connection information, and the action to deallocate an enlisted connection information includes an input argument containing the group connection information and connection information to deallocate.

In an embodiment of the present invention, if the components are demanded to be played through a plurality of devices, the conducting play-preparing operations and the requesting play of the components include conducting a play-preparing operation and a play requesting operation, with an arbitrary device pertaining to the plurality of devices, for a component to be played by the arbitrary device.

In an embodiment of the present invention, the selecting at least one component includes selecting a single component from each of at least one third structure element within the second structure element. In a case that the third structure element includes a plurality of particular structure elements containing protocol information and access location information on a resource, the selecting may include selecting a component specified by one of the plurality of particular structure elements that is determined based on information entered by a user. In addition, in a case that the third structure element includes a plurality of particular structure elements containing protocol information and access location information on a resource, the selecting may include selecting a component whose information is contained in a head element of the plurality of particular structure elements unless information for selecting is entered from a user.

An apparatus, connected to a network, for providing information on a content through the network, comprises: a storage configured for storing a plurality of content sources and item information on the content sources; and a service configured for providing the item information according to an external request. Item information, stored in the storage, on a first content sources among the content sources includes a plurality of first structure elements allocating mutually different identifiers to a primary component pertaining to the first content source and each of the plurality of first structure elements contains protocol information and access location information on the primary component. Further, the item information includes second structure elements, associated respectively with the mutually different identifiers, as many as number of the plurality of first structure elements, and each of the second structure elements contains protocol information and access location information on a resource that can be played along with the primary component.

### Advantageous Effects

At least one embodiment of the present invention as described above and described below in detail with reference to drawings improves the convenience of the user as playback together with other additional content sources can be requested by selecting a single item and increases degree of satisfaction of the user while the user's listening or watching content by making a playback operation carried out simultaneously without time delay between content sources and components within a source.

### BRIEF DESCRIPTION OF THE DRAWINGS

In the drawings:

FIG. 1 illustrates the structure of a conventional UPnP AV network;

FIG. 2 illustrates a signal flow between devices and/or services during playback of media carried out in a network of FIG. 1;

FIG. 3 illustrates structuring item information for multi-resource streaming and networked devices carrying out signal processing between devices and/or services;

FIGS. 4 and 5 illustrate a signal flow between devices and/or services for multi-resource streaming according to one embodiment of the present invention;

FIG. 6 illustrates the structure of item information carrying information about auxiliary content presented in association with a component within an arbitrary content source according to one embodiment of the present invention;

FIG. 7 illustrates the structure of item information created for a content source according to one embodiment of the present invention;

FIGS. 8 and 9 respectively illustrate examples of a screen from which a user selects an item to play according to one embodiment of the present invention;

FIG. 10 illustrates an example of a screen from which a user selects a primary component and resources to be accompanied therewith, according to one embodiment of the present invention;

FIG. 11 illustrates schematically that a single primary component and other resources are selected in associative manner from item information prepared as illustrated in FIG. 7;

FIGS. 12 and 13 respectively illustrate a signal flow between devices and/or services for streaming of multiple resources based on group connection information according to another embodiment of the present invention;

FIG. 14 illustrates the structure of actions defined in association with group connection information according to one embodiment of the present invention;

FIG. 15 illustrates management information for grouping individual connections according to one embodiment of the present invention, the management information constructed by a connection manager service installed inside a device;

FIG. 16 illustrates a conceptual scheme where instance IDs are structured for group and individual connection according to management information constructed in FIG. 15;

FIG. 17 illustrates a signal flow between devices and/or services for playing resources belonging to a selected item by assigning the resources to multiple media renderers and utilizing group connection information according to one embodiment of the present invention; and

FIG. 18 illustrates a procedure of inquiring about or controlling an arbitrary individual connection within a group connection according to one embodiment of the present invention.

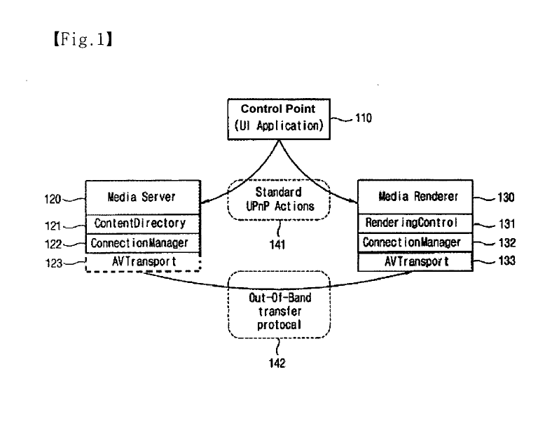

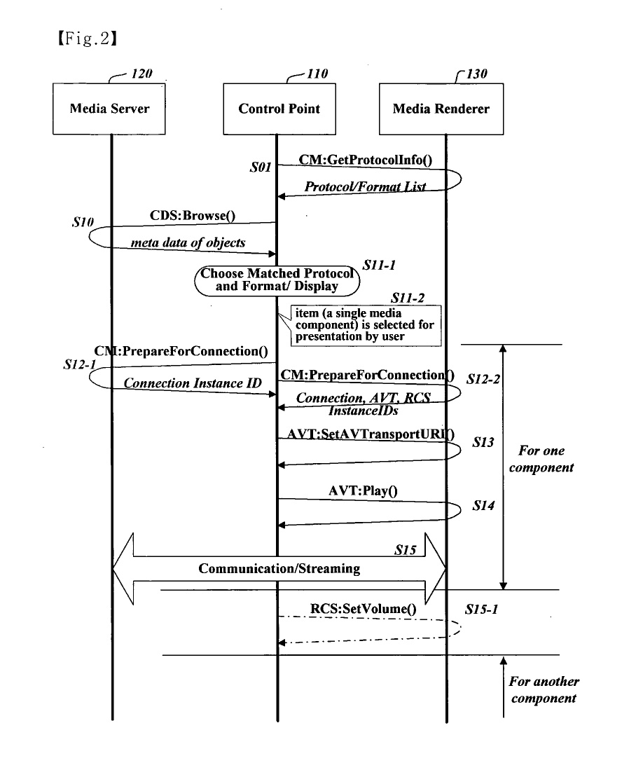

### MODE FOR THE INVENTION

Hereinafter, embodiments of the present invention will be described in detail with reference to appended drawings.

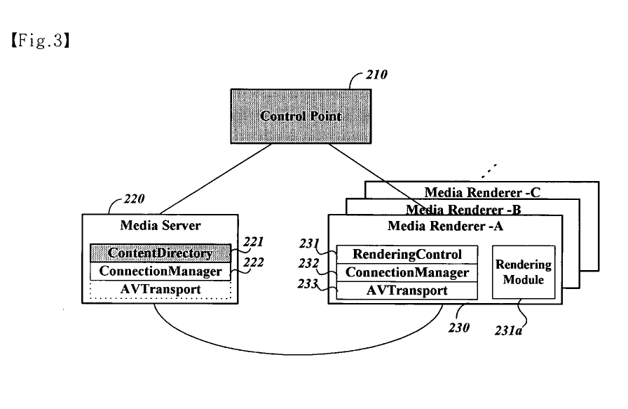

FIG. 3 illustrates networked devices carrying out structuring of item information that enables multi-presentation of multiple resources pertaining to a selected item and signal processing between devices and/or services according to the present invention. In the present invention, one content source indicates a multiple component; a multiple component comprises multiple components that are supposed to be presented in association with each other. Streaming for presenting or playing multiple content sources together through data transfer on a network is called ‘multi-content streaming’. Meanwhile, streaming of multiple components belonging to a single content source is called ‘multi-streaming’. In addition, a term of ‘multi-resource streaming’ is used to include both meanings of ‘multi-content streaming’ and ‘multi-streaming’.

The network of FIG. 3 is a UPnP AV network comprising a control point 210, a media server 220, and multiple media renderers including a media renderer A 230. Although subsequent description of the present invention is given to networked devices and/or services based on UPnP standard, what are described in the following can be directly applied to other network standards by adaptively substituting necessary elements with regard to differences of the standards where the present invention may apply. In this regard, therefore, the present invention is not limited to a network based on UPnP.

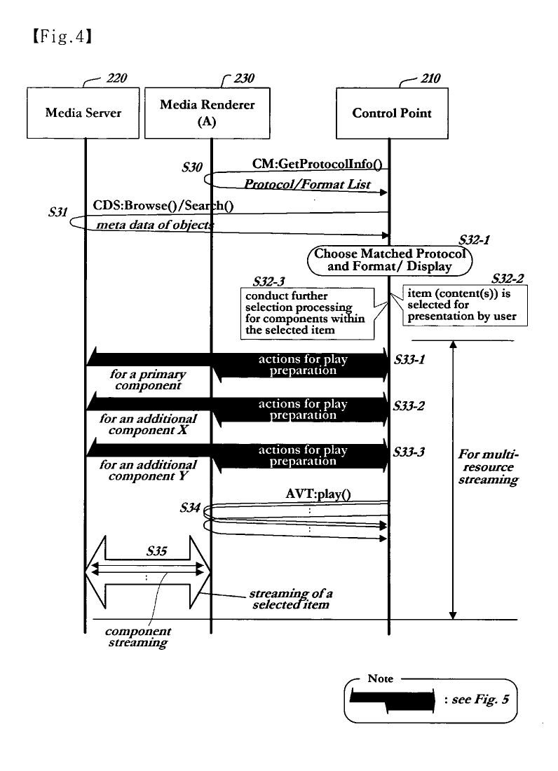

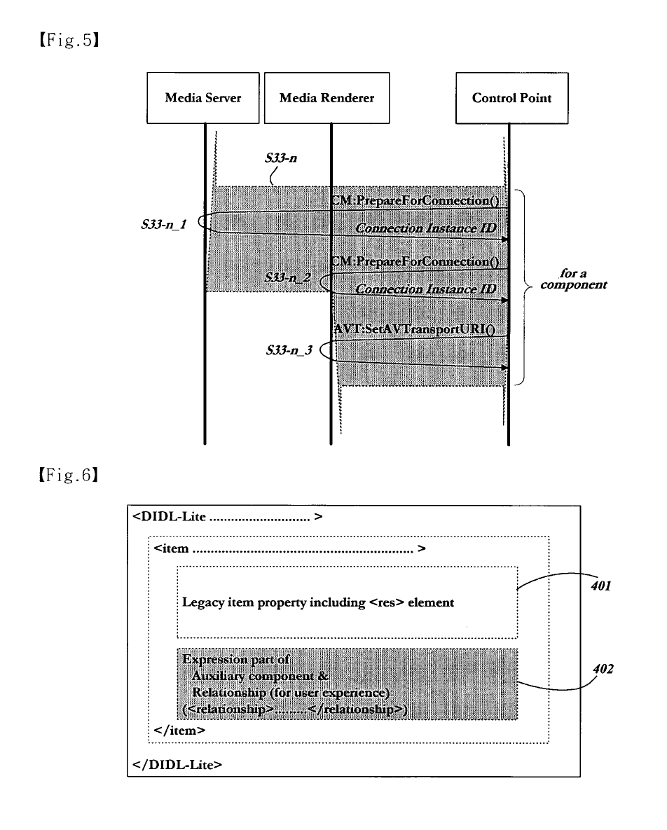

A CDS 221 (which may be a processor that runs software) within the media server 220 carries out structuring of item information for multi-resource streaming according to the present invention. In one embodiment of the present invention, the control point 210 plays a primary role in signal processing between devices and/or services for multi-resource streaming according to the present invention by following a procedure illustrated in FIGS. 4 and 5. In the following, the procedure is described in detail.

Description of configuration of devices and associated signal processing given below is based on a pull method, which is one of two methods for streaming a media component. The other method is a push method. A difference between the two methods lies in the direction of an action; devices equipped with AVTransport service for playback management of streaming or employed devices are different from each other and accordingly, the object of the action can only be either a media server or a media renderer. Since the method for carrying out an action described below can be equally applied to both push and pull methods, the scope of the present invention is not limited by those methods illustrated in the drawings and descriptions.

The CDS 221 within the media server 220 creates item information about content sources and components, namely meta data in a particular language (e.g., in XML format) by searching media files stored in a mass storage such as a hard disk or a separate removable recording medium such as an optical disk. Media files associated with each other for synchronized presentation are treated as a single content source and item information about the single content source is created. FIG. 6 illustrates an exemplary structure of item information created by the aforementioned method. As shown in the figure, with respect to a main component (e.g., AV stream) or main components among components considered to belong to a single item, in addition to item property information 401 including conventional resource elements (resource element: <res>), additionally created is information about an auxiliary component (e.g., subtitle, voice, etc) or auxiliary components and additional expression information 402 for specifying relationship in an arbitrary combination of a main component and an auxiliary component providing user experience.

The CDS 221 figures out interrelationship between media files considered as a single content source and whether a media file is a main component or an auxiliary component by utilizing, for example the name of each media file and/or extension of the file. If necessary, information about the property of each file—namely, whether the file is text or image and/or an encoding method—can also be obtained from the extension of the corresponding file. Information of each file can also be obtained by interpreting header information of the file. Alternatively, other application programs can write the aforementioned information in a database with respect to media files stored in a mass storage (or media files stored in a removable recording medium), the database being located in the same recording medium.

A structural element (<userExperienceExpression>) for the additional expression information 402 can comprise three parts. A first part is a resource element (<primary resource>) about a main component, corresponding to a structural element for assigning an identifier (ID) to a main component or main components included in the resource element within the item property information 401. A second part is a resource element about an auxiliary component (<additional resource>), corresponding to a structural element for assigning an ID to auxiliary components presented in association with the main component and recording protocol and location information for accessing the components. A third part is a set of relational elements specifying component set information from which a combination for synchronized presentation of a main component and an auxiliary component can be obtained. Each relational tag (<relationship>) represents a combination that enables presentation.

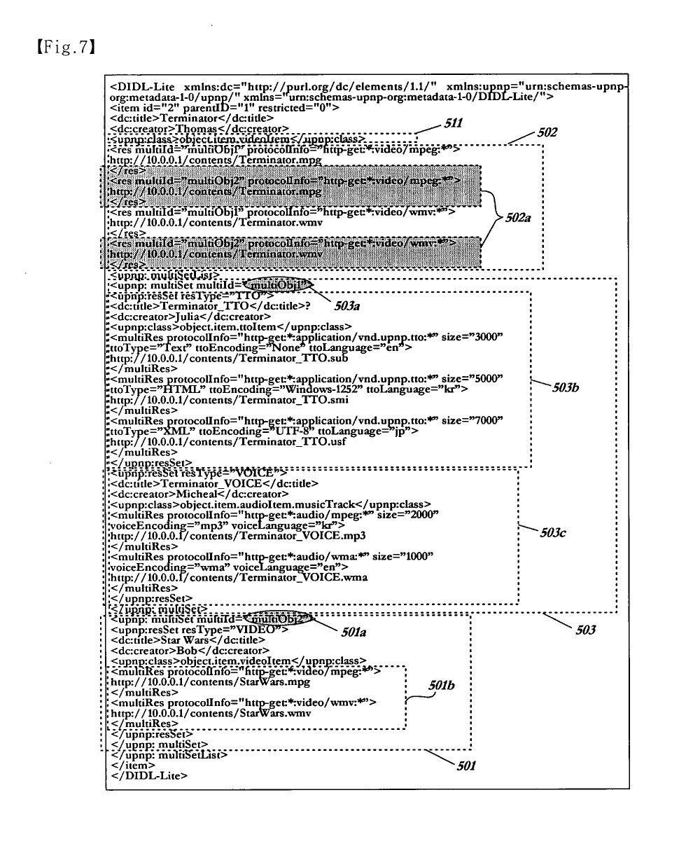

In one embodiment according to the present invention, the CDS 221, in addition to the aforementioned operations of examining interrelationship between stored media files, treating particular media files as a single content source, and writing item information about the content source, may prepare an item for a single content source as one for a content set in which a plurality of content sources including other content source additionally are mutually inter-related. FIG. 7 shows an example of item information prepared according to the present embodiment.

Information about whether to additionally associate other content sources with a single content source may be received from a user or media information provided together with the content sources. Alternatively, item information for multi-resource streaming where other content source is additionally associated besides auxiliary components is written as illustrated in FIG. 7 and may be provided for the CDS 221 through a removable recording medium on which the content sources are stored.

The embodiment of FIG. 7 is explained in detail. When preparing item information about a single content source, for example a movie title “Terminator”, the CDS 221 additionally prepares information 501 about another content source, for example a movie title “Star Wars” for multi-resource streaming as illustrated in FIG. 7. In the event that item information contains information about other content source as aforementioned, structure elements for a primary content source, for example a tag <res> are prepared 502 for both ‘play-independently’ (corresponding to ‘multi-stream’) and ‘play-together’ (corresponding to ‘multi-content streaming’) so that it is possible to select a play mode that the a primary content source (movie title “Terminator” in FIG. 7) for which item information is prepared is played together with the added content source. Furthermore, for differentiating the individual cases, a ‘multi-object identifier’ is allocated for resources of a primary component in a tag <res> as parameter value. In the FIG. 7, an example is expressed as “<res multiId=multiObjx . . . >”.

Class information, for example “object.item.videoItem” which is assigned to item information created for a single content, for example video or moving-picture content is assigned (511) to item information for a certain content that further includes source of other content as illustrated above.

In the example of FIG. 7, same multi-object identifiers are assigned to mutually different resources because there are a plurality of media files (for example, “video.mpg” and “video.wmv”) containing streaming data for a primary content source. In the example, either may be selected from both resources and a selected media resource can be played independently or together with another content source, so that two multi-object identifiers are assigned to each media resource. The meaning of ‘independently’ used herein is obviously different from ‘alone’ because play-independently includes not only play of a single media resource but also synchronous play with a media resource of other attribute, for example subtitle etc. pertaining to the same content. In the example of FIG. 7, two multi-object identifiers are assigned for play-independently and play-together with a single additional content source, however, if another additional content source is included the number of tags <res>, each being for a single media resource, to which same multi-object identifier is assigned is increased accordingly.

The CDS 221 specifies a multi-object identifier, protocol information, access location information and so on for primary media resources (video files containing video data of movie “Terminator” in the example of FIG. 7) of a primary content source by tags <res>, and writes information about auxiliary components and/or additional content sources to be playable with the media resource in another structure element, for example a multi-set list tag <multiSetList>.

The CDS 221 prepares at least one multi-set tag <multiSet> in the multi-set list tag and writes in each multi-set tag information related with a set of auxiliary components 503 to be playable in synchronization with a primary media resource, or information related with additional content source 501 or sources. In addition, the CDS 221 inserts a multi-object identifier 501a or 503a, which was previously assigned within the tag <res> for a primary media resource, in each multi-set tag <multiSet> to link a single multi-set with a primary media resource.

Information is prepared in the multi-set as follows. The CDS 221 classifies types of auxiliary components and/or additional content source considered to pertain to a single multi-set and then writes corresponding information. Information on components (pertaining to a primary content source and an additional content source) whose types are classified same is written in a single resource-set tag <resSet>. For example, video, audio (or voice), subtitle etc. may be one of the types to be classified. The term of ‘video’ used for types may include a type of ‘audio/video’. Information about type is written as value of a parameter ‘resType’ within the resource-set tag <resSet> as illustrated in FIG. 7. Further, title and class are specified by corresponding tags in every resource-set tag.

The tag <resSet> includes a single or a plurality of components. If there are a plurality of components of same type a single tag <resSet> includes a plurality of components. For a type, e.g., video, audio, subtitle or selective combination thereof, a single tag <resSet> is made for video components, for example (components 501b corresponding to files “StarWars.mpg” and “StarWars.wmv” in the example of FIG. 7). Protocol information and location information for access of each component (i.e., resource) pertaining to the tag <resSet> are specified by a tag <multiRes> for the component. The tag <multiRes> functions like the tag <res> that specifies protocol information and access location information for a single resource, however, it has name “multiRes” different from the tag <res> because information specified by the tag <multiRes> is about a resource to be played in auxiliary manner with one among certain resources 502 that are primary components.

If there are several types of components pertaining to a primary content source (excluding a primary media resource) or an additional content source as afore-mentioned, a plurality of tags <resSet> are prepared as illustrated in FIG. 7. For example, auxiliary resources to be played in synchronization with the primary media resource “Terminator” are, as illustrated in FIG. 7, classified into two types: ‘subtitle’ (TTO) for components 503b containing subtitle data for displaying words of actors on a movie; and ‘audio’ or ‘voice’ (VOICE) for components 503c containing audio data for outputting words of actors in voice of English or Korean. In the example of FIG. 7, tags <multiSet> are made for the additional content source in such way that only video type of resources are included in the tag <resSet>. However, it is a matter of course that another tag <resSet> for the additional content source can be made to further include different type of auxiliary resources, for example, subtitle or audio type of components to be played in synchronization with the video type of resource. In this case that such type of resources are additionally included, a tag <resSet> is added accordingly and related information is inserted in the added tag.

When item information for multi-resource streaming is prepared as shown in FIG. 7, information about an additional content source, namely, information etc. written in the tag <multiSet> may be prepared with reference to item information on the additional content source that has been prepared independently.

In the above-mentioned embodiment, item information is made as illustrated in FIG. 6 when preparing item information, which does not support multi-content streaming, for multi-streaming of a single content source. In another embodiment according to the present invention, item information is made as illustrated in FIG. 7 even if there is no additional content source. In other words, even when preparing item information for multi-streaming of a single content source item information is made in the structure illustrated in FIG. 7. In this case, all structure elements related with an additional content source are removed. For example, structure elements 502a and 501 in which multi-object identifier ‘multiObj2’ is allocated are deleted in the structure of item information illustrated in FIG. 7.

In the above-mentioned embodiment, item information is made in form of multi-resource streaming structure as illustrated in FIG. 7 when preparing item information for an arbitrary content source. In another embodiment according to the present invention, item information for multi-resource streaming illustrated in FIG. 7 is additionally prepared besides item information about a single content source. Explaining in more detail, both item information for independent streaming and item information ensuring multi-content streaming shown in FIG. 7 are prepared together for a movie title “Terminator”.

The name of each individual structure element (e.g., tag) used in FIG. 7 (e.g., <streamSet>, <resSet>) is only an example. Utilizing a different name not indicated in the present invention for achieving the same functionality provided by a tag employed in the present invention is equally acceptable.

If an item is selected by a user after item information prepared as shown in FIG. 7 is provided for the CP 210, the CP 210 can know, based on multi-object identifiers allocated in the multi-set list tag <multiSetList> or the resource tags <res>, whether the selected item supports multi-resource streaming. Then, the CP 210 provides selection menu for a user to select a primary media resource, an auxiliary media resource and/or an additional content source. As explained above, the CP 210 further provides selection menu for a user to select one from auxiliary media resources, to be played in synchronization with a primary media resource, within a multi-set tag <multiSet> in the embodiment that item information for a single content source (not including an additional content source for ‘play-together’) is prepared in structure shown in FIG. 7 as mentioned above.

Item information composed as shown in FIG. 6 and/or item information for multi-resource streaming prepared as shown in FIG. 7 are transferred from the CDS 221 to the CP 210 in response to a browsing action or a search action and are interpreted by the CP 210. According to the interpretation, the CP 210 provides the user with relevant information for selecting components to play. According to the user's input, an operation of multi-content streaming (or multi-streaming) is carried out. Detailed descriptions of the operation are given below.

FIGS. 4 and 5 illustrate a signal flow between devices and/or services for multi-resource streaming according to one embodiment of the present invention. Item information created by CDS 221 within the media server 220 through the afore-mentioned method is transferred from the CDS 221 to the CP 210 by a browsing action or a search action of the CP 210 (S31). As a matter of course, before the above action, as shown in FIG. 4, the CP 210 requests and obtains supported protocol information from all of media renderers including a media renderer A 230 (S30).

The CP 210, from among information of objects received from the step S31, provides the user through an appropriate user interface (UI) only with those objects (items) having protocol information supported by the media renderer A 230 that the user has specified for presentation of content (S32-1). At this time, the CP 210 analyzes information received by an action and carries out subsequent operations (S32-2) that allow the user to select desired content or a desired component within a content.

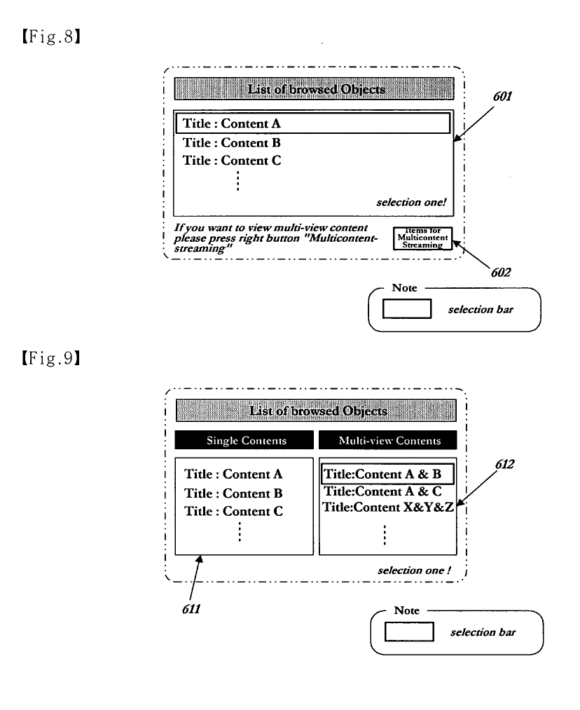

The CP 210 extracts item information of a content source supporting only independent play from received item information and outputs a list 601 of the extracted item information as shown in FIG. 8. The item supporting only independent play means an item prepared in structure shown in FIG. 6 or an item prepared without an additional content source which is structured like FIG. 7. If the received item information also includes item information structured as FIG. 7 for supporting multi-content streaming the CP 210 may provide on a screen a menu or a button 602 for selecting an item ensuring multi-content streaming which will come into effect of multi-view to a user. The multi-view means concurrent view of a plurality of contents. If a user requests an item guaranteeing ‘multi-content streaming’ or ‘multi-view’, the CP 210 selects, from the received item information, items of which information includes multiple mutually different multi-object identifiers or multiple multi-set tags <multiSet> and provides a screen listing the selected items, thereby allowing the user to select one item from the listed items. To help the user make a selection, for each item, the CP 210 may display information within <title> tag recorded in the item information on the screen.

In another embodiment according to the present invention, the CP 210 analyzes information received through an action and it may display a single-content window 611 and a multi-view content window 612 together as shown in FIG. 9 if information of an item guaranteeing multi-content streaming is also included. When displaying 612 multi-view contents the CP 210 combines a text of title written in the item with a text of title within a multi-set tag <multiSet> included as additional content source and displays the combined text. For example, in the event that the title of a selected item is “Content X” and the title within a multi-set tag <multiSet> for an additional content source is “Content Y”, a combined text “Content X & Content Y” is displayed. Such text combination ensures a user to know what content sources are played together in a case that a user requests multi-content streaming after selecting a corresponding item.

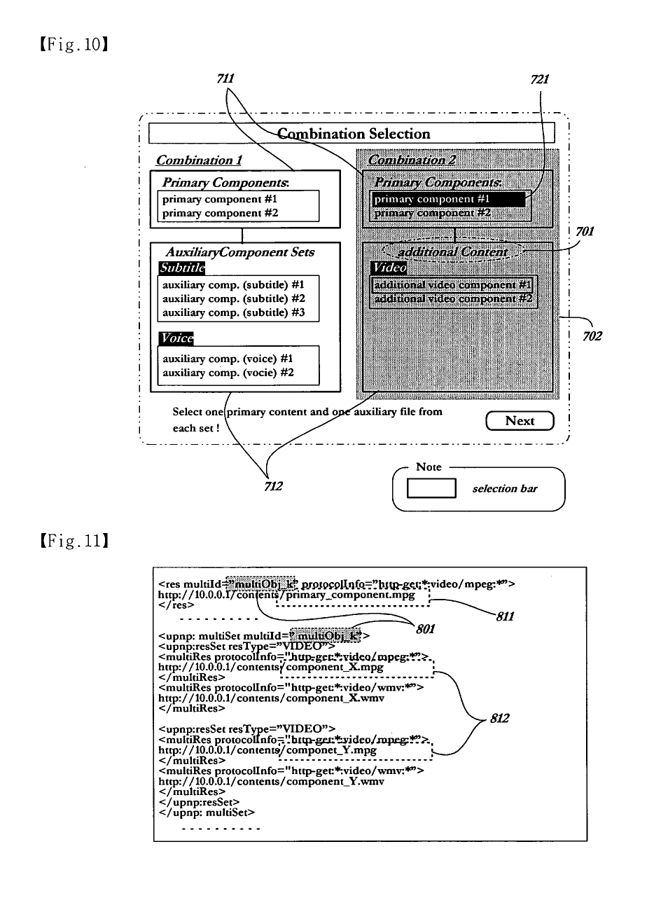

If information of an item selected from a selection menu provided as FIG. 8 or 9 is in structure illustrated in FIG. 7, the CP 210 analyzes the information of the selected item to know what resource combinations are playable and provides selection windows from which a playable combination is selected, as illustrated in FIG. 10. In the displayed example of FIG. 10, each combination is corresponding to each multi-set written in a multi-set list and the number of combinations is equal to the number of multi-sets or mutually different multi-object identifiers that are allocated in the tags <res> for a primary resource. When organizing and displaying selection combinations, the CP 210 considers resources of same multi-object identifier as a single combination. In displaying operation, the CP 210 may use a guide title 701, distinguishable from that of auxiliary components to be played synchronously each other, for an additional content source including a video component.

User's selection of a single combination from the selection windows illustrated in FIG. 10 exactly means that a single multi-object identifier is determined by the CP 210. For example, if the left combination ‘combination 1’ is selected by a user from the selection windows illustrated in FIG. 10 a multi-object identifier ‘multiObj1’ is determined by the CP 210 in the example of item information shown in FIG. 7, and if the right combination ‘combination 2’ is selected another multi-object identifier ‘multiObj2’ is determined. The exemplary drawing of FIG. 10 shows that the right combination window is activated 702 after the corresponding combination window is selected.

The CP 210 further provides inner windows 712 for a user to individually select auxiliary components or components of an additional content source besides inner windows 711 for selection of a primary media resource. The inner windows for individual selection of auxiliary components or components of an additional content source are separated each other by types of components contained therein. That is, same type of components are grouped and then contained in a single inner window such that one component is selected by a user from each type of components (resources), namely from each inner window. The information, for example a text informing component type is displayed at top of each grouped selection set (namely, each inner window). In the example of FIG. 10, “Subtitle”, “Voice” and “Video” are displayed at top of each selection set. Information needed for displaying at top of each selection set may be retrieved from value of an attribute parameter of a tag <resSet> wherein the attribute parameter is defined by the CDS 221 and its value is also written by the CDS 221. In another embodiment, the information needed for displaying may be obtained from protocol information (protocolInfo=“ . . . ”) specified by a resource tag <multiRes> of an auxiliary or an additional component. Each of grouped selection sets is structured in association with each multi-set tag <resSet> in the example of FIG. 7.

When a selection of a component is made from the inner window or the grouped selection set, a component already selected is displayed with an outstanding mark 721 differentiating the component from other components that are not been selected—for example, by inverting the display of the selected component, whereby the user can easily recognize the selected component.

When a user is requested to select a resource, the user may not select any component. In this case, the CP 210 may select a component to be streamed by using a default method. For example, the CP 210, if specific selection is not made for a component from a provided selection set, a resource specified by a head <multiRes> tag within each <resSet> tag is selected as a streaming component. In another embodiment of the present invention, when no component within <resSet> tag is selected, a parameter may be defined and used for indicating that a particular component has been selected. For example, as in <multiRes default=TRUE.>, it can be specified that the corresponding resource is a component selected by default.

If selection of resources for multi-resource streaming is made according to the above-mentioned processes the selection may be a combination (selection of the combination 1 in FIG. 10 will result in multi-streaming) of a primary component and an auxiliary component to be played in synchronization with the primary component, or another combination (selection of the combination 2 in FIG. 10 will result in multi-content streaming) of a primary component and a component of an additional content to be played with the primary component. The CP 210 obtains protocol information and URL information about each resource from related structure elements. That is, the CP 210 obtains them from information contained in a tag <res> (in case of a primary component) or another tag <multiRes> (in case of an auxiliary component or an additional component) of each selected component in the item information illustrated in FIG. 7.

If protocol information of a component obtained from the above procedure is not compliant with the protocol supported by the media renderer A 230 (which is destined by the user for a device for presentation), the corresponding component is ignored and operations for presentation at the media renderer A 230 described below are not carried out for the component. Instead, the user may receive an alarm message saying “The selected component cannot be played at the destined media renderer!”.

The CP 210 conducts preparing operations (S33-n, n=1, 2, . . . ) for concurrent play of resources whose protocol information and URL information are known. The example of signal flow shown in FIG. 4 is for a case that three components (one primary component and two additional video components) are chosen from a selected item illustrated in FIG. 11. In the example, same preparing operations are conducted between devices and/or services three times (S33-1,S33-2,S33-3). Furthermore, in the example of FIG. 11, a multi-set including two selection sets for additional video components and a primary component “primary component.mpg” 811 linked therewith by a multi-object identifier ‘multiObj_k 801 are selected by a user, and components “component_X.mpg” and “component_Y.mpg” 812 are further selected respectively from the linked selection sets. As a result, the signal flow illustrated in FIG. 4 is conducted.

Specific illustration of actions carried out at each preparation operation is given at FIG. 5. As illustrated in FIG. 5, an action is carried out for a single selected component belonging to a single content source and an input argument of the action has adequate information for the component.

Signal processing between devices and/or services illustrated in FIG. 5 is described in detail. The CP 210 invokes actions for preparing connection (PrepareForConnection( )) from the media server 220 and the media renderer A 230 respectively for a corresponding component and receives connection information, for example instance ID assigned by participating elements (services) required for presentation through streaming (S33-n_1, S33-n_2). The received instance IDs are used for later specifying and controlling the corresponding component employed by a current streaming service. If the CP 210 receives an instance ID for connecting the component through the action for preparing connection (the instance ID is a set of IDs assigned to each service. It is called, however, an instance ID for the sake of convenience. In what follows, if description, e.g., name of each individual service is not given before an ID, the instance ID represents a set of instance IDs about individual services assigned to a single connection), the CP 210 sets access location information about previously selected components, for example URL information respectively to AVTransport service 233 (S33-n_3).

For the sake of convenience for drawing diagrams and description, it has been described that an action for preparing connection and an action for setting access location information (SetAVTransportURI( )) are carried out sequentially according to the order of each component but it does not necessarily follow the aforementioned order of performance. For example, after completing an action for preparing connection with respect to a primary component and additional content sources X and Y, an action for setting access location information may be invoked on components belonging to the primary component and the additional content sources X and Y. An action for setting access location information upon an arbitrary component can be invoked any time once an action for preparing connection has been previously invoked on the corresponding component. Under the above conditions, therefore, various methods for invoking an action for preparing connection and setting access location information can be employed in addition to the aforementioned method.

After an action for setting access location information has been invoked for all of the selected components and a success response has been received according to the invocation, an action for playing is invoked to AVTransport service 233 for each component (S34). Preferably, the playback actions are invoked simultaneously.

An AVTransport service 233 of the media renderer A 230 that received the playback action for each component makes a component about a connection specified by an instance ID of input arguments of each playback action streamed or downloaded through a relevant information exchange procedure in a media server 220. Accordingly, the selected components are streamed or downloaded from the media server 220 and under control of RenderingControl service 231, are decoded and output by a rendering module 231a consisting of corresponding decoders (or a decoder of integrated functions) (S35). In the above-explained example, components played together are additional video components. However, components to be played together may be auxiliary components, for example, resources of subtitle or voice data to be played in synchronization with a primary component. Such is the case that a primary component of which multi-object identifier is ‘multiObj1’ is chosen by a user in the example of FIG. 7. In this case, auxiliary components are decoded and outputted in synchronization with a primary component under control of the service RenderingControl 231.

In another embodiment according to the present invention, multiple renderers can carry out multi-resource streaming by dividing up content sources or components. For example, after a primary component included in a selected item is destined for a media renderer A, and a component X (or a voice type of auxiliary component) and a component Y (or subtitle type of auxiliary component) of an additional content source are destined for media renderers B and C respectively, connection preparing actions, access location information setting actions and play actions are invoked to corresponding media renderers. Except for a playback action, required actions may be invoked irrespective of the order of the media renderers and time. The playback actions, however, are invoked after a success response with respect to the last of actions required for each media renderer has been received. It is desirable that invocation of playback actions upon media renderers should be carried out simultaneously.

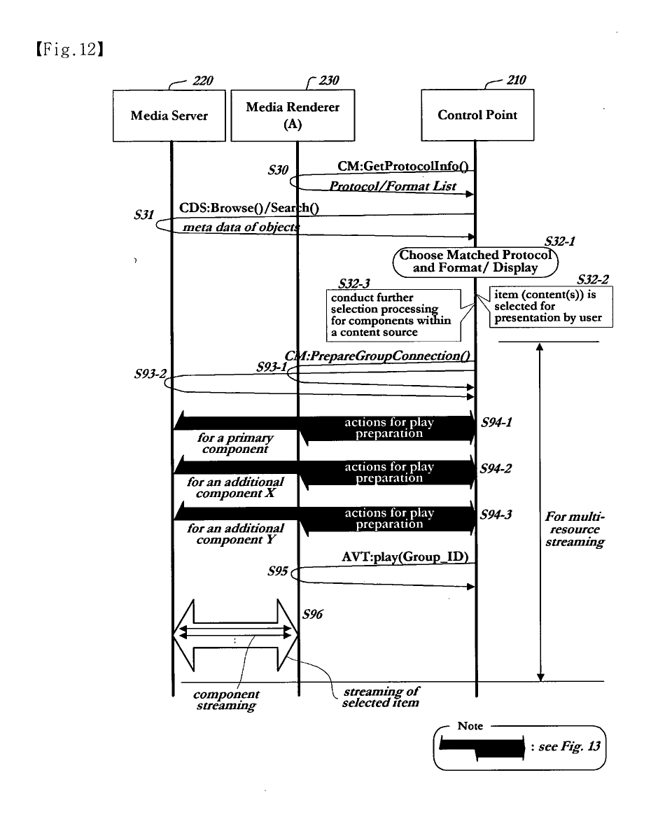

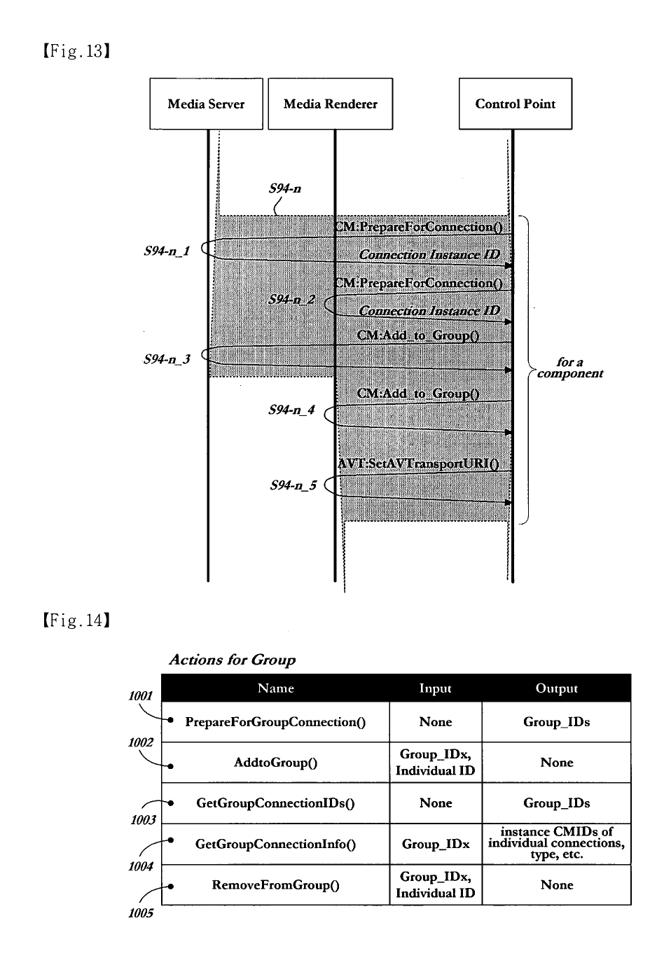

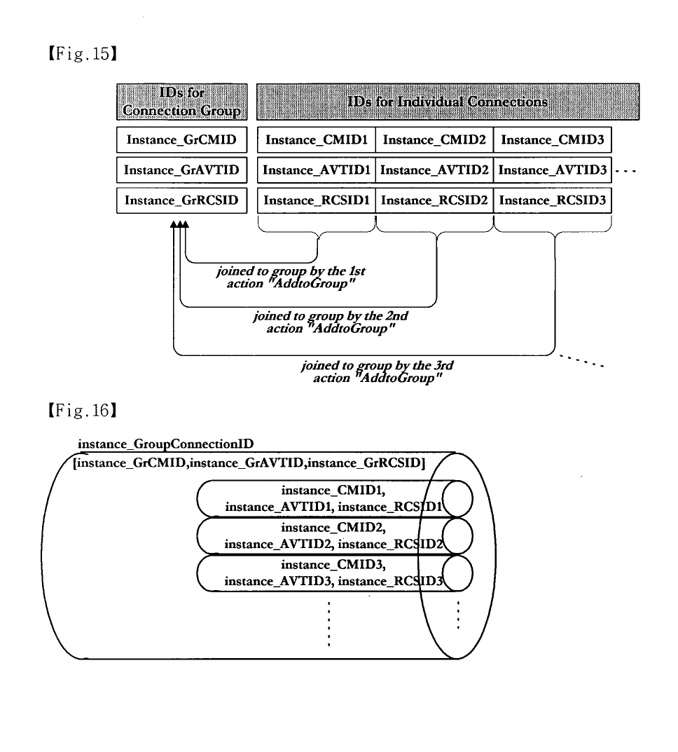

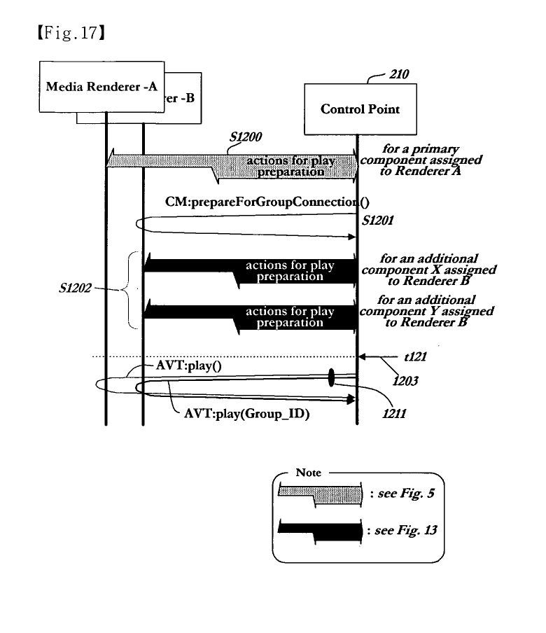

In another embodiment according to the present invention, connections for all of selected components are grouped and an identifier for the grouped connections (called ‘group-connection’ hereinafter) is used in later operations for multi-resource streaming of a selected item. FIGS. 12 and 13 illustrate procedures for multi-resource streaming in accordance with the present embodiment.

The explanation about the steps S30, S31 and S32-1 to S32-3 in FIG. 12 is omitted herein because the steps are conducted the same way with corresponding steps that was explained with reference to FIG. 4. First, the CP 210 invokes a group connection preparing action ‘PrepareForGroupConnectionQ’ for a group connection to CM services 222 and 232 of both devices (a media server 220 and a media renderer A 230) (S93-1,S93-2). The group connection preparing action is in structure 1001 illustrated in FIG. 14, so that information on a group connection, for example a virtual instance ID is received through carry by an output argument from the media server 220 and the media renderer A 230 in response to the invocation. The virtual instance ID means an instance ID that is not associated with a single actual connection and it is handled as an instance ID to identify a group connection.

The CP 210 conducts preparing operations for multi-resource streaming for each component of which protocol information and URL information are known (S94-n, n=1, 2,). The example of signal processing shown in FIG. 12 is, like FIG. 4, for a case that three components (a primary component and additional components X and Y) are selected from item information. In the example of FIG. 12, three identical preparation operations (S94-1, S94-2, S94-3) are carried out between devices and/or services. Specific description about actions carried out during each preparation operation is given in FIG. 13. As shown in FIG. 13, an action is carried out for a single component and input arguments of an action have adequate information associated with a corresponding component.

Signal processing between devices and/or services illustrated in FIG. 13 is described in detail.

The CP 210 invokes connection preparation actions (PrepareForConnection( )) for individual connection (which is intended to represent a connection created for a single component in contrast with ‘group connection’) for a corresponding component to the media server 220 and the media renderer A 230 respectively and receives an instance ID assigned by participating services to be involved in presentation through streaming between devices (S94-n_1, S94-n_2).

When the CP 210 receives an instance ID of each participating service (CM, AVT, or RCS) about individual connection of a corresponding component through an action for preparing connection, the CP 210, to group received instance IDs about individual connection, invokes an action for adding to a group (AddtoGroup( )) having the structure illustrated in FIG. 14 as many times as the number of individual connections (S94-n_3, S94-n_4). The action for adding to a group is for linking an instance ID for individual connection with an instance ID (a virtual instance ID assigned for identifying the group connection) for group connection received (S93-1, S93-2) through the previous action for preparing group connection. At this time, input argument of the action for adding to a group includes an instance ID for group connection according to the structure illustrated in FIG. 14 and an instance ID for individual connection to be enlisted in the group connection.

Although a connection preparation action for individual connection is invoked for a component (S94-n_1, S94-n_2) after a group connection preparation action for group connection has been invoked (S93-1, S93-2) in the embodiment of FIG. 12, invocation of the action can be carried out in a reverse order. In other words, it is sufficient that by carrying out a group connection preparation action and a connection preparation action for individual connection irrespective of the order, an instance ID for individual connection to be added to a group and an instance ID for a group connection are prepared before carrying out the action for adding to group.

The CM service 222 or 232, after receiving an action for linking the instance ID, constructs management information for mapping an instance ID for group connection contained in each group addition action onto an instance ID for individual connection. FIG. 15 illustrates an example of management information for grouping individual connections (since the media renderer A 230 of FIG. 3 is equipped with AVTransport service 233 and an instance ID about AVTransport service has been provided by a connection preparation action in response to the action, the instance ID of AV-Transport service is included in an instance ID for a connection), the management information being constructed by ConnectionManager service 232 within the media renderer A 230. FIG. 16 illustrates a conceptual scheme where instance IDs are structured for group and individual connection according to the management information constructed in FIG. 15. In addition to mapping information about instance IDs illustrated in FIG. 15, if there exists additional information received through input arguments of an action for preparing group connection and an action for adding to group (for example type, information about whether an individual connection is a main or an auxiliary component, and the like), the received information is also stored as management information and thus managed by the CM service 222 or 232.

After construction of mapping information illustrated in FIG. 15, each ConnectionManager service 222, 232, in response to the request of the CP 210 for playback management or rendering control utilizing an instance ID of a connection group, identifies an instance ID of individual connection corresponding to a service requested for an action and utilizes the instance ID, thereby specifying the corresponding resources available.

After grouping individual connections by using the above operations, an action for setting access location information about a corresponding component (e.g., URL information) to AVTransport service 233 (SetAVTransportURIO) is invoked (S94_n_5).

After completing operations for preparing playback of components selected for multi-resource streaming (after completion of the operation S94-3 in the example of FIG. 12), the CP 210 invokes a playback action on AVTransport service 233. The action uses a previously received instance ID (Instance GrAVTID) of AVTransport service for group connection (S95). The instance ID of AVTransport service for group connection transferred by the action is mapped onto instance IDs of AVTransport service for individual connection by ConnectionManager service 232 and the mapped instance IDs are transferred to AVTransport service 233, enabling playback operations of individual connections to start at the same time. Next, through a relevant information exchange procedure between the media renderer A 230 and the media server 220, components selected from item information are all streamed or downloaded from the media server 220 and are decoded and outputted by the rendering module 231a under control of RenderingControl service 231 (S96). At this time, those components requiring synchronized playback between components are presented in synchronization with each other.

As described earlier, the user can request presentation of selected components to be played through separate multiple media renderers. In this case, the CP 210 dose not establish a group connection for all of the selected components but establishes a group connection by components that are directed to the same device. As a matter of course, a group connection is established in the event that there are multiple components to be streamed to a single device.

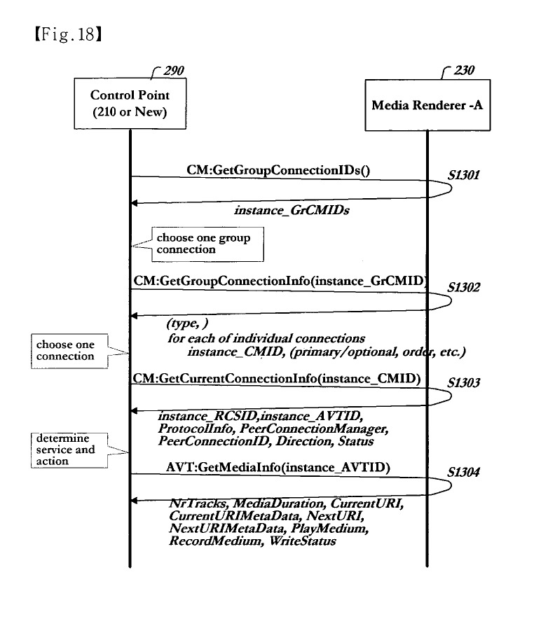

FIG. 17 illustrates signal processing for playback using group connection information based on the assumption that components are designated for presentation being distributed across media renderers A and B. Since a single primary component is assigned to the media renderer A connection preparing action illustrated in FIG. 5 is conducted for the media renderer A as shown in the figure (S1200). In the meantime, an action for preparing group connection is invoked to the media renderer B to which a plurality of additional components are assigned (S1201). According to the invocation of group connection preparing action, operations for preparing multi-resource streaming are carried out by using an instance ID of a group connection received from CM service of the media renderer B (S1202). After operations for preparing playback of all of selected components have been completed (in the example of FIG. 17, after t121 at which a success response to the last action has been received), the CP 210 invokes a playback action using an instance ID of an individual connection and a playback action using an instance ID of a group connection to AVTransport services of the media renderers A and B, respectively. In this case, it is desirable that invocation 1211 of playback actions using an instance ID of an individual connection or a group connection upon media renderers should be carried out simultaneously.

While operations of presentation being carried out according to the above procedure S35, S96, if a request for controlling a playback operation with respect to particular content or components (playback stop, temporary stop, search, trick play, etc) or a request for changing rendering state (adjustment of volume, stopping audio output, adjustment of brightness, etc) is made by the user, the CP 210 requests the corresponding action (e.g., AVT:Stop( ), AVT:Pause( ), PCS:SetVolume( ), RCS:SetMute( ), etc) from a media renderer. In response to the request, an instance ID for a group connection assigned to multi-content streaming in service or an instance ID for an individual connection can be employed. For the case of using an instance ID for an individual connection, since a device or a service invoked by an action can immediately recognize a connection corresponding to the instance ID and resources assigned to the connection, operations requested by an action with respect to the connection or resources are carried out.

In case of using an instance ID for a group connection, a service that receives an action, when the instance ID for an individual connection corresponding to the action is specified by a single instance ID, maps the instance ID for an individual connection directly onto the instance ID of the corresponding group connection and carries out operations for a individual connection of the instance ID, for example control operations. For instance, when individual connections corresponding respectively to the components of video, audio, and text attribute are set up as a group connection and a Volume( ) action that adjusts loudness of sound has been received through an instance ID of the group connection, the instance ID of the group ID can be directly mapped onto the instance ID of a connection set up for a component of audio attribute from among instance IDs for the three individual connections.

When the above mapping is inappropriate (for example, a group connection comprises multiple components of the same attribute or a group connection is set up for resources including an additional content component as illustrated in the previous example) and a particular action is invoked, an instance ID for an individual connection within a group connection is retrieved and used, which is described in the following.

By grouping individual connections through a procedure as described above and delivering required information to a related service through an action, the user can select a desired one from among grouped individual connections and carry out inquiring about or controlling the connection through the CP 210 that created the corresponding group connection or through a different CP that has newly participated in the network.

FIG. 18 is one example of the above operation, illustrating a procedure of inquiring of information related to play of a component corresponding to a particular individual connection belonging to a group connection. FIG. 18 assumes a situation where an action is invoked on the media renderer A 230 but the action can necessarily be invoked on a different device, for example the media server 220. As shown in the figure, CP 290 of FIG. 18 invokes an action for inquiring about devices specified by the user—group connections currently set up for the media renderer A 230 in the example of FIG. 18—on ConnectionManager (CM) service 232 within the media renderer A 230, the action (GetGroupConnectionIDs( )) having the structure 103 illustrated in FIG. 14. Accordingly, instance IDs (instance GrCMIDs) of CM service 232 about currently established group connections are received (S1301).

The CP 290 selects one group connection from the received information. At this time, necessary conditions for selecting a group connection are determined by information entered by the user. Once a group connection is selected, an action for inquiring of group connection information (GetGroupConnectionInfo( )) is invoked on the CM 232, the action having the structure 1004 illustrated in FIG. 14 and having an instance ID of CM about the group connection (instance GrCMID) as an input argument. The CM 232, in response to the invocation, delivers CM instance IDs of all the individual connections belonging to the group connection specified by the input argument of the action from among management information managed for a current group connection to the CP 290 (S1302). If additional information is contained in the management information, the additional information—for example, type of a group connection (e.g., multi-content streaming, multi-streaming, subtitle synchronization, audio synchronization, etc)—and information about whether a component of each individual connection is primary or auxiliary are delivered together to the CP 290.

The CP 290 selects an individual connection from received information. Necessary conditions for selecting an individual connection are determined based on information entered by the user and received information. If received information carries only instance IDs of CM service about individual connections, making it difficult for the user to select, the CP 290 invokes an action for inquiring of connection information (GetCurrentConnectionInfo( )), which is described below, on each of instance IDs of the received CM service without the user's request and receives information and presents the received information together with the instance IDs, helping the user select an individual connection.

If an individual connection is determined by the user, an action for inquiring of current connection information (GetCurrentConnectionInfo( )) is invoked on the CM 232, the action having CM instance ID (instance_CMID) about the individual connection as an input argument. According to the invocation, information about the individual connection (instance IDs of other services, protocol information, etc as shown in FIG. 18) is received (S1303).

The CP 290, by using received information, determines target services of an action relevant to the user's request and types of actions and invokes a determined action on the corresponding determined service. In the example of FIG. 18, media information is requested from AVTransport service 233. Since the above request is related to an action for AVTransport service 233, from the previously received information, instance_AVTID, which is an instance ID of AVTransport service, is used as an input argument of the action. According to the action, the AVTransport service 233 delivers a variety of state information of the corresponding connection as shown in FIG. 18 and managed by the AVTransport service 233 to the CP 290 (S1304).

An established group connection is removed by the request of the CP (210 or 290) when the user requests removal or it is determined that multi-resource streaming is not further required. As for the removal, the CP (210 or 290), for each individual connection to be removed, invokes an action for removing from a group (RemoveFromGroupQ) on the CM service 222, 232, the action removing an individual connection from a group connection and having the structure 1005 illustrated in FIG. 14. As shown in FIG. 14, the above action includes an instance ID for a group connection and an instance ID for an individual connection to be removed from a connection group as input arguments.

The CM (222 or 232) that received the action for removing from a group, from ID mapping information organized as in FIG. 15, erases an instance ID identical to the instance ID for an individual connection included in the input argument of a received action linked with an instance ID for a group connection included in the input argument of the received action. Each time an instance ID for an individual connection is erased from ID mapping information by the action for removing from a group (RemoveFromGroupQ), the CM service 222, 232 examines mapping information of an instance ID for the corresponding group connection and if no more instance ID for an individual connection related to the group connection remains, removes assignment of an instance ID for a group connection of the mapping information and reserves the removed instance ID to be reused for a different group connection.

The foregoing description of a preferred embodiment of the present invention has been presented for purposes of illustration. Thus, those skilled in the art may utilize the invention and various embodiments with improvements, modifications, substitutions, or additions within the spirit and scope of the invention as defined by the following appended claims.

1. A method for preparing information on a stored content source, comprising: creating a plurality of first structure elements allocating mutually different identifiers to a primary component pertaining to a content source, and incorporating protocol information and access location information on the primary component into each of the plurality of first structure elements; and creating second structure elements as many as number of the plurality of first structure elements, and incorporating into each of the second structure elements protocol information and access location information on a resource that can be played along with the primary component, the second structure elements being respectively associated with the mutually different identifiers.

2. The method of claim 1, wherein if the second structure element includes information on mutually different types of resources, the second structure element includes a plurality of third structure elements that are separated each other, each of the third structure elements containing information on same type of resources.

3. The method of claim 2, wherein the third structure element includes at least one particular structure element being capable of specifying protocol information and access location information on a resource.

4. The method of claim 3, wherein the particular structure element is different from the first structure element in name.

5. The method of claim 2, wherein a type is assigned to the third structure element and the type is one among video, audio, subtitle, and a selective combination thereof.

6. The method of claim 1, wherein at least one resource selected from one of the second structure elements is a component that can be played in synchronization with the primary component.

7. The method of claim 1, wherein at least one resource selected from one of the second structure elements is a video component that can be played along with the primary component.

8. The method of claim 1, wherein the first structure element is an information element specified by a tag <res>.

9. The method of claim 1, further comprising
incorporating into information on the content source class information that is identical to class information assigned to item information of a single content.

10. A method for conducting presentation of a content through data transfer over a network, comprising:
obtaining an identifier assigned to a first structure element that specifies protocol information and access location information on a selected primary component;
selecting at least one component included in a second structure element associated with the obtained identifier; and
conducting play-preparing operations for the primary component and the at least one component, and requesting play of the components after the play-preparing operations are finished for all of the components.

11. The method of claim 10, wherein the play-preparing operations include, for each of the primary component and the selected at least one component:
invoking a connection preparing action to obtain connection information from each of services to be involved in play operation; and
invoking another action to set information necessary for component access to a play managing service.

12. The method of claim 11, wherein the play requesting includes invoking play actions for the components respectively.

13. The method of claim 10, wherein the play-preparing operations include:
invoking an action to obtain group connection information from each of services to be involved in play operation; and
for each of the primary component and the selected at least one component, invoking a connection preparing action to obtain connection information from each of the services, and
invoking another action to enlist the obtained connection information in the obtained group connection information, and invoking another action to set information necessary for component access to a play managing service.

14. The method of claim 13, wherein the play requesting includes invoking a single play action using the group connection information.

15. The method of claim 13, wherein the another action to enlist the obtained connection information in the obtained group connection information includes input arguments containing the group connection information and connection information to enlist.

16. The method of claim 13, further comprising
invoking an action to deallocate an enlisted connection information from the group connection information, the action to deallocate an enlisted connection information including an input argument containing the group connection information and connection information to deallocate.

17. The method of claim 10, wherein if the components are demanded to be played through a plurality of devices, the conducting play-preparing operations and the requesting play of the components include conducting a play-preparing operation and a play requesting operation, with an arbitrary device pertaining to the plurality of devices, for a component to be played by the arbitrary device.

18. The method of claim 10, wherein the selecting includes selecting a single component from each of at least one third structure element within the second structure element.

19. The method of claim 18, wherein in a case that the third structure element includes a plurality of particular structure elements containing protocol information and access location information on a resource, the selecting includes selecting a component specified by one of the plurality of particular structure elements that is determined based on information entered from a user.

20. The method of claim 18, wherein in a case that the third structure element includes a plurality of particular structure elements containing protocol information and access location information on a resource, the selecting includes selecting a component whose information is contained in a head element of the plurality of particular structure elements unless information for selecting is entered from a user.

21. An apparatus, connected to a network, for providing information on a content through the network, comprising:
a storage configured for storing a plurality of content sources and item information on the content sources; and
a service configured for providing the item information according to an external request,
wherein item information on a first content sources among the content sources includes a plurality of first structure elements allocating mutually different identifiers to a primary component pertaining to the first content source, each of the plurality of first structure elements contains protocol information and access location information on the primary component, the item information includes second structure elements as many as number of the plurality of first structure elements, and each of the second structure elements contains protocol information and access location information on a resource that can be played along with the primary component, the second structure elements being respectively associated with the mutually different identifiers.

22. The apparatus of claim 21, wherein at least one resource selected from one of the second structure elements is a component that can be played in synchronization with the primary component.

23. The apparatus of claim 21, wherein at least one resource selected from one of the second structure elements is a video component that can be played along with the primary component.
